(19) United States
(12) Patent Application Publication
(10) Pub. No.: US 2026/0315980 A1
(43) Pub. Date: Oct. 15, 2026

(54) AIR FILTER ASSEMBLY & AIR FILTER

(71) Applicant: Australian Mitigation Engineering Developments Pty Ltd, Ipswich (AU)

(72) Inventor: Peter Woodford, Mile Rocks (AU)

(73) Assignee: Australian Mitigation Engineering Developments Pty Ltd, Ipswich (AU)

(21) Appl. No.: 19/698,743

(22) Filed: Jun. 4, 2026

Related U.S. Application Data
(63) Continuation of application No. PCT/AU2024/051327, filed on Dec. 9, 2024.

(30) Foreign Application Priority Data
Dec. 7, 2023 (AU) 2023903968

(51) Int. Cl. B01D 46/46; B01D 46/00

(52) U.S. Cl. CPC B01D 46/46; B01D 46/0002; B01D 46/0045; B01D 2273/30

(57) ABSTRACT

An air filter assembly comprising a housing assembly comprising an inlet housing having an inlet receiving air and an outlet dispensing air, and a filter housing connected to the inlet housing to receive air; a fan with one or more blades drawing air into the inlet housing. The filter assembly including an airflow control system positioned relative to the fan to cause air drawn into the inlet to rotate within the inlet housing toward the filter housing and cause particles within the air to be forced toward a wall of the housing; a removable air filter located within the filter housing for filtering the rotating air flow received from the inlet housing, the air filter having an internal passage to receive air from the filter housing; and an ejection port connected to the internal passage of the air filter ejecting air received into the internal passage of the air filter.

### TECHNICAL FIELD

The present invention relates to an air filtering assembly and an air filter for use therewith.

### BACKGROUND

Any references to methods, apparatus or documents of the prior art are not to be taken as constituting any evidence or admission that they formed, or form part of the common general knowledge.

Existing air precleaners and filtration methods utilized in internal combustion engines, ventilation and HVAC systems, and similar devices for separating heavier-than-air debris involve various mechanisms. These include systems with a motor-driven fan drawing in debris-laden air, along with those relying solely on the vacuum produced by the clean air-supplied device. However, these systems encounter several shortcomings.

Current air filtration systems suffer from design flaws leading to significant air intake restrictions. This results in reduced air filter lifespan, compromised HVAC service life, engine performance, and decreased fuel efficiency. Operating under a vacuum, these systems experience quicker filter loading (i.e., filled with air laden debris) creating higher initial air intake resistance, necessitating more frequent servicing. Many systems feature precleaners that trap airborne debris, demanding manual removal of captured particles. Some technologies use a dump valve to release trapped debris via the force of gravity, but these valves often clog, especially in the presence of moisture or mixed debris in the airflow. Some systems attempt to scavenge separated debris using a vacuum device, which leads to additional components to capture and eliminate the scavenged debris, prone to clogging with moist or mixed airflow.

The size and weight of current air filtration systems designed to generate specific airflow for downstream devices lead to installation and serviceability issues. Custom manufacturing is often required due to configuration and performance variations, limiting the systems' adaptability and increasing manufacturing time and costs. Examples of these variations include separate components for precleaning and disposing of separated debris, airflow direction through the filter, clean air outlet location, filter size and style, supporting structure placement, and specific airflow rates required for downstream system performance. In powered air precleaners, the motor's lifespan is reduced due to decreased airflow for motor cooling as the filter loads, causing excess heat on the motor. Additionally, the buildup of debris in the separator chamber poses risks during filter servicing, potentially reducing engine life or introducing debris into HVAC and ventilation systems.

In essence, current air filtration systems encounter issues related to airflow restriction, premature filter wear, manual debris removal, clogging in dump valves or scavenging systems, as well as challenges in size, weight, and customization, ultimately impacting their efficiency, durability, and adaptability to various applications.

### SUMMARY OF INVENTION

In an aspect, the invention provides an air filter assembly comprising:
a housing assembly comprising an inlet housing having an inlet for receiving air, and a filter housing connected to the inlet housing to receive air therefrom;
a fan with one or more blades for drawing air into the inlet housing;
an airflow control system positioned relative to the fan to cause air drawn into the inlet to rotate within the inlet housing toward the filter housing and cause particles within the air to be forced toward a wall of the housing;
a removable air filter located within the filter housing for filtering the rotating air flow received from the inlet housing, the air filter having an internal passage to receive air from the filter housing through walls of the air filter; and
a clean air outlet connected to the internal passage of the air filter for ejecting air received into the internal passage of the air filter.

Preferably, an ejection port is formed in the filter housing. Preferably, the ejection port is configurable between an open configuration and a closed configuration. Preferably, in the open configuration debris-laden air is ejected from the ejection port and in the closed configuration the debris-laden air is filtered through the air filter.

Preferably, the air filter assembly further comprises a spigot connected to the inlet housing such that the inlet is between a body of the inlet housing and the spigot. The spigot (in some embodiments a duct spigot or air inlet spigot) is configured to connect to a source of air (i.e., a hose or pipe communicating air from a cabin to the air filter assembly). Preferably, the spigot is substantially conical.

Preferably, the air filter assembly further comprises an interlock arrangement to operate and control the fan and/or a motor of the fan when the air filter is located within the air filter housing. That is, the air filter assembly may comprise an interlock arrangement to operate and control the fan and/or a motor of the fan in response to the air filter being located within the air filter housing.

Preferably, the interlock arrangement includes a sensor or magnet or sensor and magnet connected to the air filter. Preferably, the air filter includes one or more sensors or magnets. Preferably, the one or more sensors or magnets are located at an end of the air filter. Preferably, there are two sensors or magnets located at the end of the air filter and spaced apart about the end of the air filter.

Preferably, the interlock arrangement includes a control sensor or control switch located in the housing assembly and configured to detect the presence of a sensor or magnet of the air filter. Preferably, the control sensor or control switch is positioned within the housing assembly to be adjacent or directly adjacent the sensor or magnet of the air filter when the air filter is operably located within the housing assembly. Preferably, the control sensor or control switch is connected to and/or configured to operate and/or control the fan in response to detection of the sensor or magnet of the air filter. Preferably, the control sensor or control switch is configured to detect a sensor or magnet of the air filter that is adjacent or directly adjacent the control sensor or control switch. Preferably, in use, without detection of the sensor or magnet of the air filter, the fan will not operate.

In another aspect, the invention provides an air filter for use in an air filter assembly having a sensor or magnet located thereon, wherein the sensor or magnet is operably located and configured to communicate with a corresponding sensor or switch.

In another aspect, the invention provides a method of operating an air filter assembly, the method including:
providing an air filter having a sensor or magnet located thereon,
operably locating the air filter within a housing assembly of an air filter assembly, whereby the operable location of the air filter within the housing assembly positions the magnet or sensor in operable communication with a corresponding control switch or control sensor located within the housing assembly to control a fan of the air filter assembly that draws air into an inlet of an inlet housing of the housing assembly for filtering.

In another aspect, the invention provides a method of configuring an air filter assembly, the method including:
providing a filter housing having an open ejection port formed therein,
configuring the ejection port in a closed configuration by closing the open ejection port to provide for recirculation within a housing assembly of the air filter assembly.

Preferably, the method includes configuring the ejection port in an open configuration by opening the ejection port.

### BRIEF DESCRIPTION OF THE DRAWINGS

Preferred features, embodiments and variations of the invention may be discerned from the following Detailed Description which provides sufficient information for those skilled in the art to perform the invention. The Detailed Description is not to be regarded as limiting the scope of the preceding Summary of the Invention in any way. The Detailed Description will make reference to a number of drawings as follows:

FIGS. 1 and 2 illustrate perspective views of an air filter assembly;

FIG. 3 illustrates a cross-section view of the air filter assembly;

FIG. 3A illustrates a close up view of the sensors of the air filter assembly;

FIGS. 4 to 6 illustrates the inlet housing;

FIG. 7 illustrates an air filter for use with the air filter assembly;

FIGS. 8 and 9 illustrate perspective views of the air filter assembly having a cover attachment attached thereto;

FIGS. 10 to 13 illustrate the cover attachment including the cover and adaptor;

FIGS. 14 and 15 illustrate perspective view of the air filter assembly having a recirculation spigot attached thereto; and

FIG. 16 illustrates the recirculation spigot.

### DETAILED DESCRIPTION OF PREFERRED EMBODIMENTS

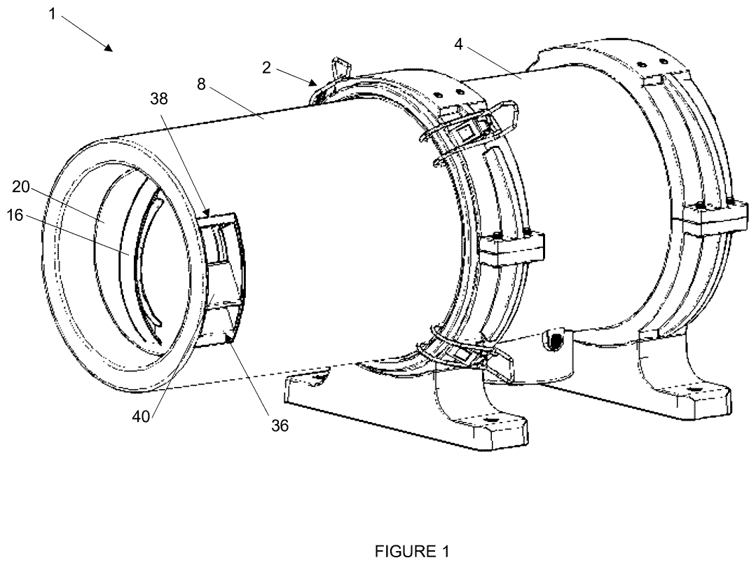

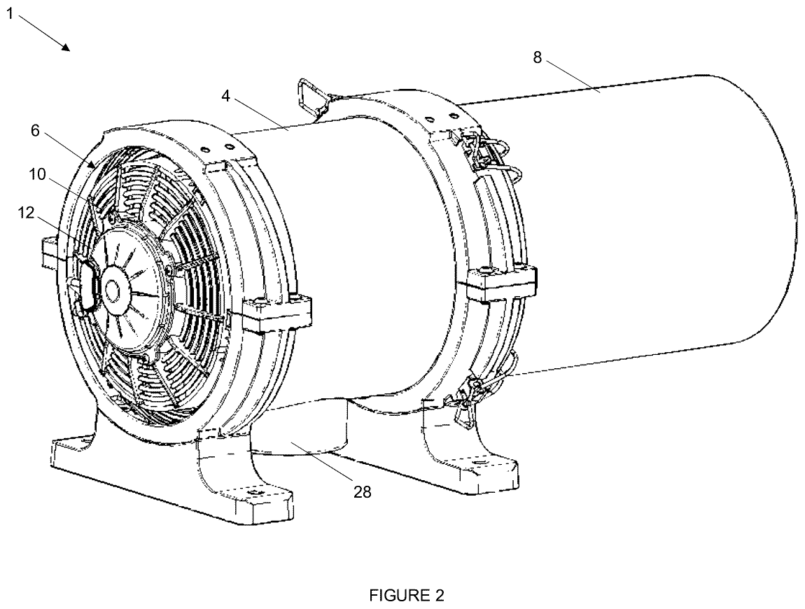

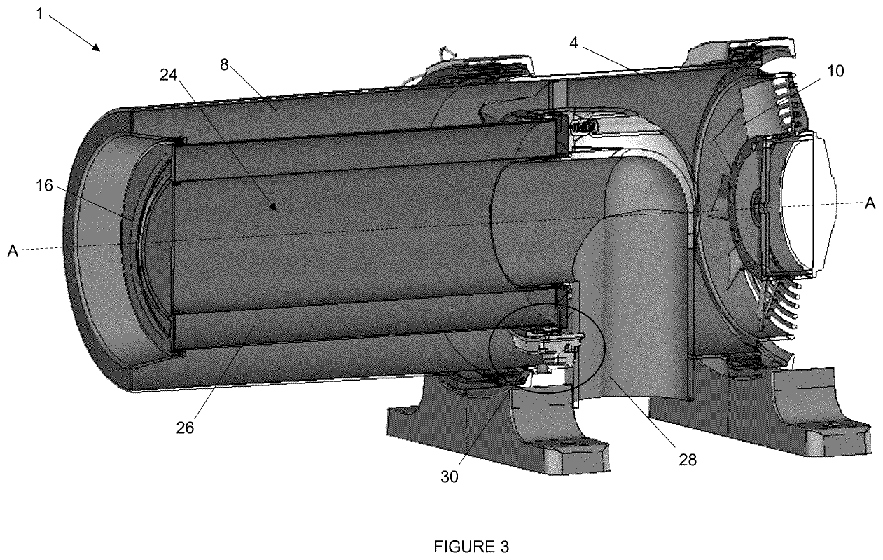

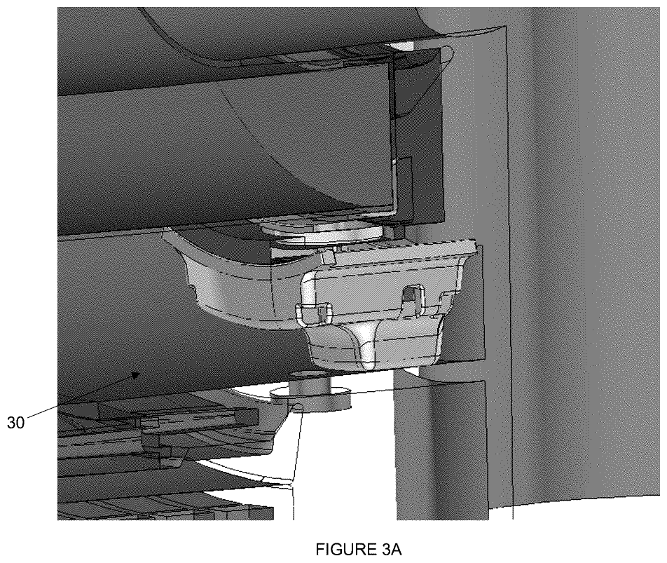

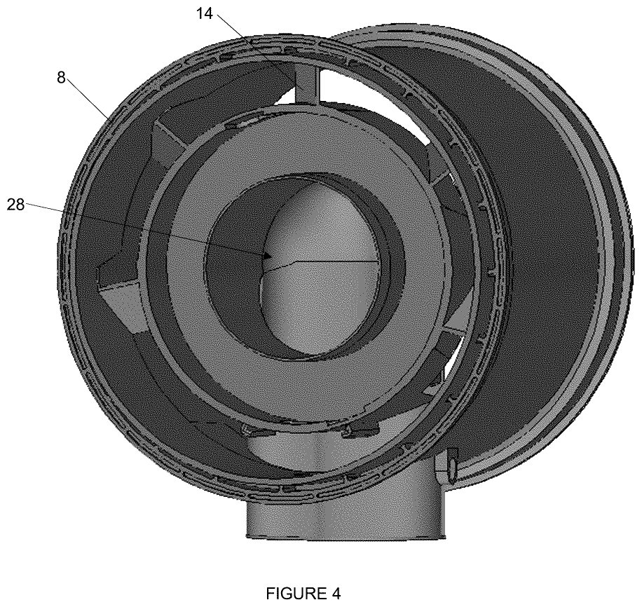

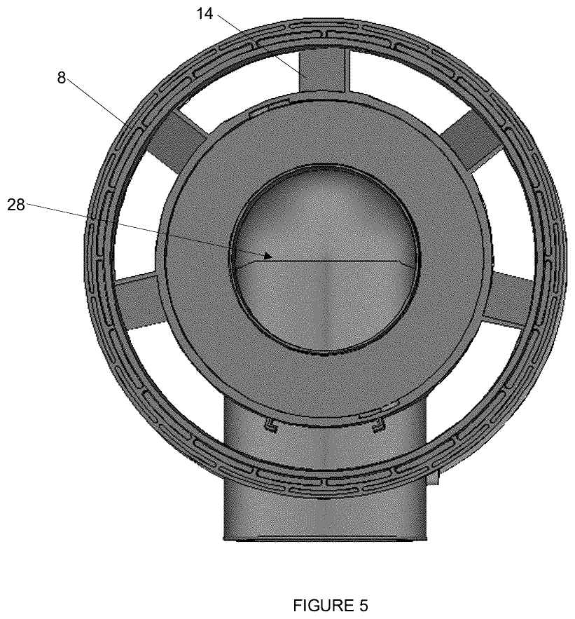

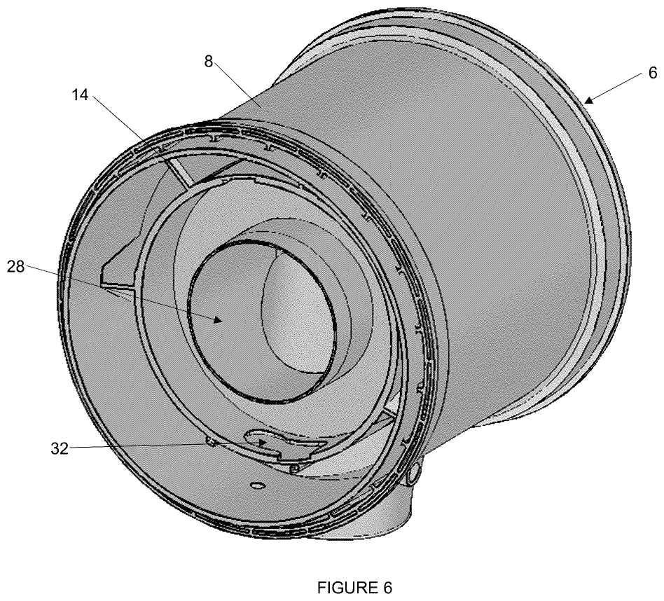

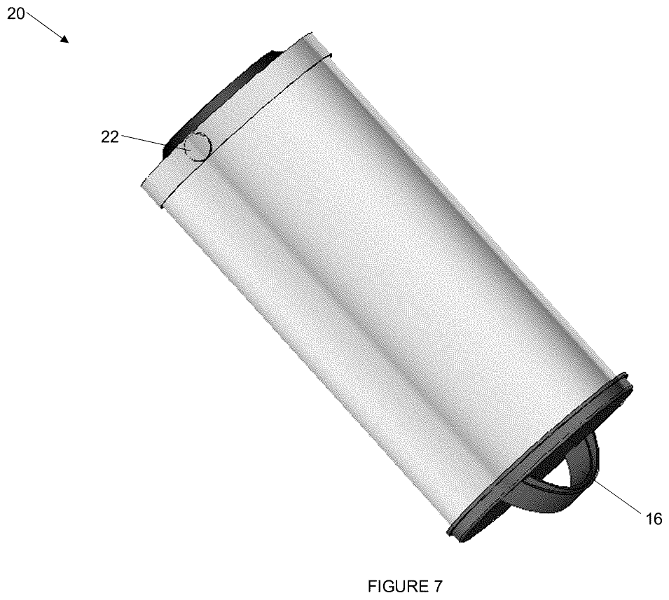

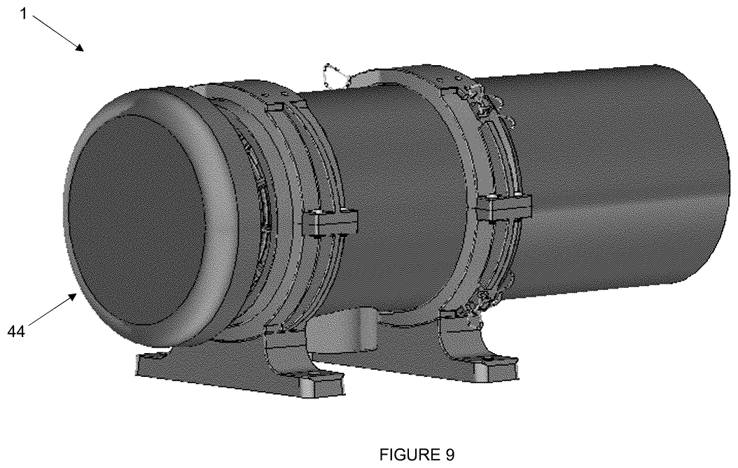

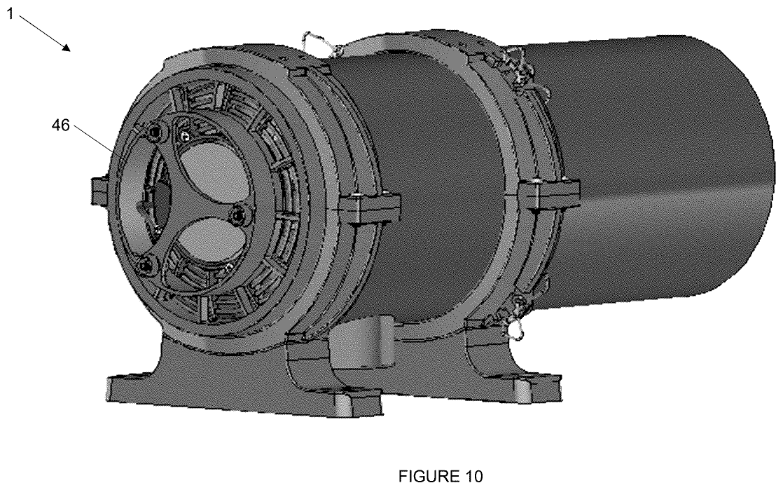

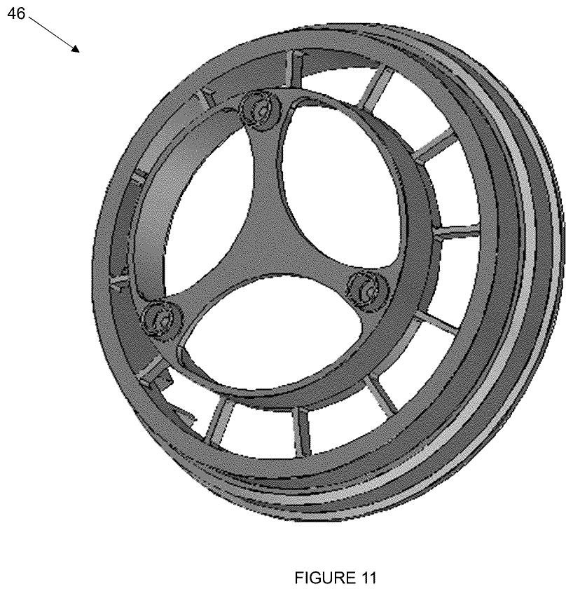

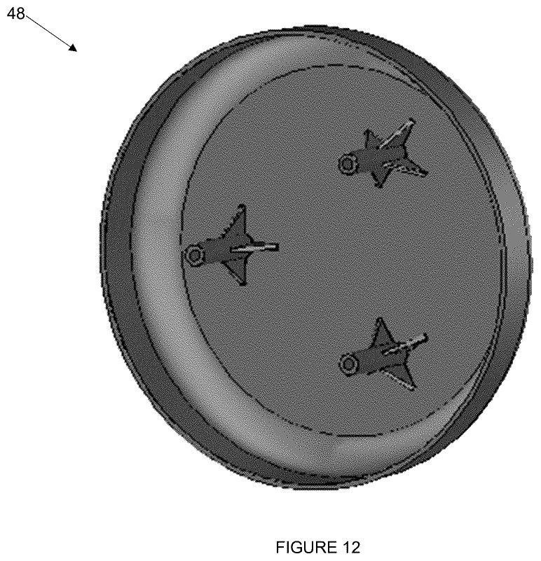

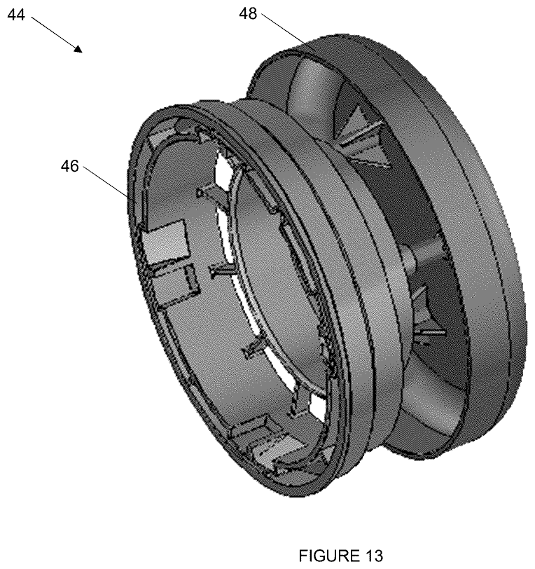

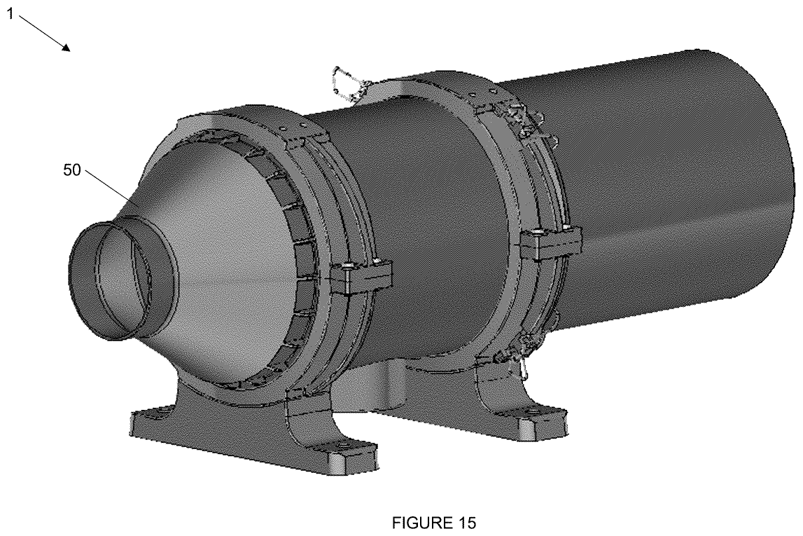

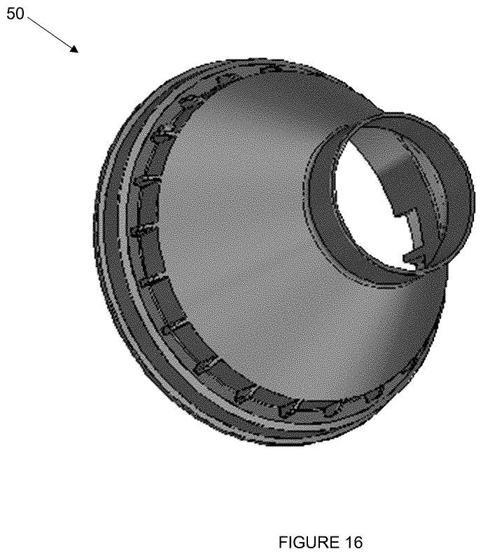

FIGS. 1 to 16 illustrate an air filter assembly 1.

The air filter assembly 1 includes a housing assembly 2 that includes two housing portions: an inlet housing 4 having an inlet 6 for receiving air and a filter housing 8 connected to the inlet housing 4 to receive air therefrom.

The air filter assembly 1 also includes a fan 10 powered by a motor 12 located within the inlet housing 4 or connected to an end thereof. The fan 10 has a plurality of blades for drawing air into the inlet housing 4 from the surrounding environment.

An airflow control system 14 is positioned relative to the fan 10 to cause air drawn into the inlet 6 to rotate as it moves from the inlet housing 4 toward the filter housing 8 and thus cause heavier than air particles within the air to be forced toward a wall of the housing assembly 2. In the illustrated embodiment, the airflow control system 14 is integrally formed with the inlet housing 4 but in some embodiments the airflow control system 14 may be a discrete component.

The airflow control system 14 provides a plurality of vanes 18 that direct the flow of air as it moves from the inlet housing 4 to the filter housing 8 to cause a centrifugal effect.

The air filter assembly 1 provides a removable air filter 20 located within the filter housing 8 for filtering the rotating air flow received from the inlet housing 4 into the filter housing 8. The air filter 20 includes a handle 16 attached to an end thereof for easy insertion and removal within the filter housing 8. The handle 16 also closes off or seals the end of the air filter 20.

The removable air filter 20 is to be understood to refer to a removable air filter element that is received by and, in use, located within the filter housing 8.

The removable air filter 20 includes a sensor or magnet or sensor and magnet (preferably as part of an interlock arrangement for controlling the operation of the air filter assembly 1) located thereon, wherein the sensor and/or magnet is operably located and configured to communicate with a corresponding sensor and/or switch that may preferably be located within the filter housing 8. In the illustrated embodiment, the removable air filter 20 includes a magnet 22 in the form of a neodymium magnet. As an example, the magnet 22 may operably interact with a corresponding switch or a sensor to initiate the control of the air filter assembly 1. This will be described in greater detail elsewhere. The sensors described herein may be understood as referring to both active and passive sensors, where appropriate. However, in some preferable embodiments, the sensors may be passive-type sensors.

The air filter 20 includes an internal passage 24 to receive air from the filter housing 8 through walls 26 of the air filter 20 which is then ejected from the air filter assembly 1 via clean air outlet 28 connected to the internal passage 24 of the air filter 20.

The fan 10, inlet housing 4, filter housing 8 and air filter 20 are all generally centrally aligned along a longitudinal axis A-A extending from a centrepoint of an end of the inlet housing 4 to a centrepoint of an end of the filter housing 8. The fan 10 is arranged radially relative to the axis A-A (i.e., the blades of the fan 10 extend radially from the axis) while the inlet housing 4, filter housing 8 and air filter 20 are arranged axially relative to the axis A-A.

The air filter assembly 1 also includes an interlock arrangement 30 to operate and control the fan 10 and/or a motor 12 of the fan 10 when the air filter 20 is operably located within the filter housing 8. That is, the interlock arrangement 30 is operably configured to control the fan 10 of the air filter assembly 1 when the air filter 20 is operably located within the filter housing 8. The air filter 20 should be understood to be operably located within the filter housing 8 when it is securely located within the filter housing 8 such that the air filter 20 performs appropriate filtering functionality during operation of the air filter assembly 1. That is, the interlock arrangement 30 may be configured to operate and control the fan 10 or the motor 12 or the fan 10 and the motor 12 in response to the air filter 20 being located within the air filter housing 8.

The interlock arrangement 30 can include any combination of magnets, sensors and/or switches that can be configured to cooperate to control the operation of the fan and/or motor of the air filter assembly 1. This could include a magnet and hall effect sensor, or an RFID arrangement, for example.

The air filter 20, in some embodiments, may be securely located within the filter housing 8 by way of a complementary recess 32 formed in the airflow control system 14 that is shaped to receive a portion of the air filter 20 (in this embodiment, the complementary recess 32 receives a housing of the magnet) such that the complementary recess 32 receives the air filter 20 which is then rotated about a longitudinal axis to prevent the withdrawal of the air filter 20 simply by pulling the air filter 20.

The interlock arrangement 30 includes a sensor or magnet connected to the air filter 20 (as mentioned elsewhere). For convenience, the air filter 20 may include one or more sensors or magnets.

The sensors or magnets may be located at an end of the air filter 20, as shown in the illustration. However, it will be appreciated that the exact position of the sensors or magnets on the air filter will be, at least in part, governed by the position of the corresponding of the control sensor or control switch within the housing assembly the sensor or magnet communicates with. As such, the sensor or magnets must be located on the air filter such that the sensors or magnets will operably engage or communicate with the corresponding control switch or control sensor when the air filter is operably located within the housing assembly. In the illustrated embodiment, there are two magnets 22 located at the end of the air filter 20 and the magnets 22 are spaced apart about the end of the air filter 20. The magnets 22 are spaced about by 180 degrees about the circumference of the cylindrical body of the air filter 20.

The interlock arrangement 30 also includes a control sensor or control switch located in the housing assembly and configured to detect the presence of a sensor or magnet of the air filter 20. Preferably, the control sensor or control switch is positioned within the housing assembly to be adjacent or directly adjacent the sensor or magnet of the air filter when the air filter is operably located within the housing assembly. The control sensor or control switch is connected to and/or configured to operate and/or control the fan 10 in response to detection of the sensor or magnet of the air filter 20. In particular, the control sensor or control switch is configured to detect a sensor or magnet of the air filter 20 that is adjacent or directly adjacent the control sensor or control switch. Thus, in use, without detection of the sensor or magnet of the air filter 20 by the control switch or control sensor, the fan 10 will not operate. In the illustrated embodiment, a control sensor taking the form of a hall effect sensor 34 is provided which cooperates with the magnet 22 of the air filter 20.

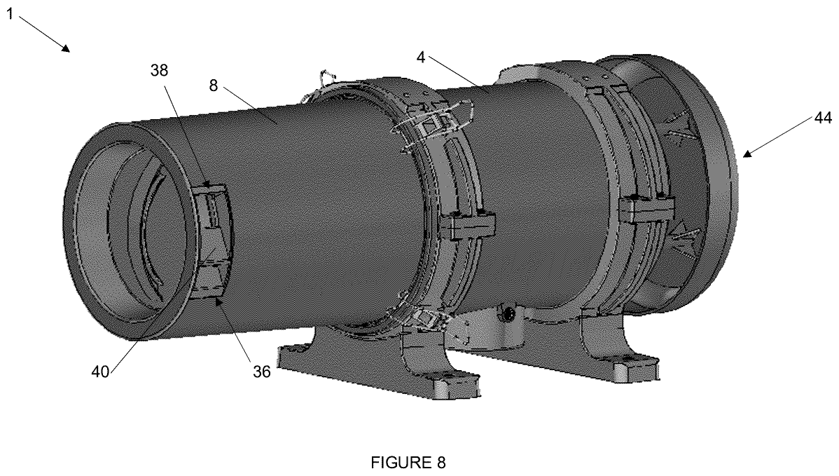

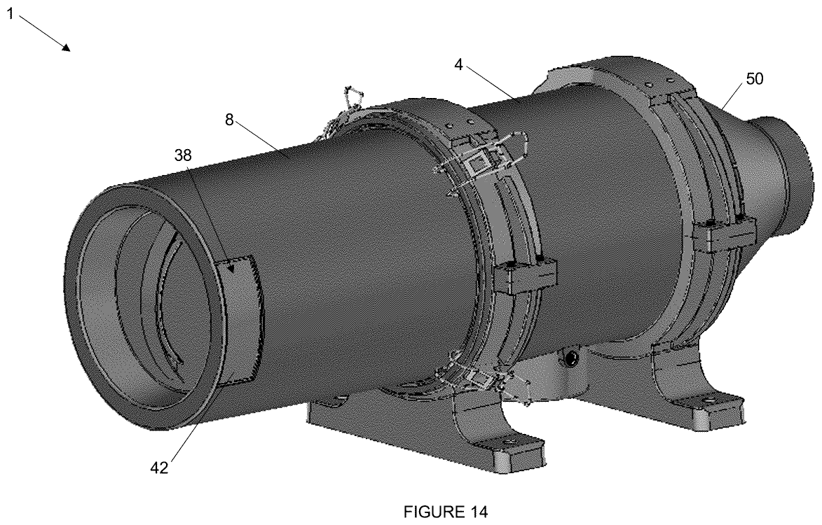

Located at an end of the filter housing 8 is an ejection port 36. This second ejection portion 36 is preferably located at an end or adjacent an end of the filter housing 8 that is distal from the inlet housing 4. The ejection port 36 is configurable between an open configuration (see FIG. 8) and a closed configuration (see FIG. 14) to control the operational capabilities of the air filter assembly 1 which will be described in more detail elsewhere. The provision of the ejection portion 36 within the filter housing 8 allows for a single air filter to be used across multiple configurations and uses for the air filter assembly 1.

The second ejection port 36 may be so configured by provision of a rotating collar located within the wall of the filter housing or by way of a sliding port cover arrangement 38 including a first portion 40 located in the ejection portion 36. The first portion 420 has an opening 41 which allows debris-laden air to exit the housing. The sliding port cover arrangement 38 also includes a sliding cover portion 42 that is adapted to cover or seal the opening 41 and thereby close the ejection port 36. In some embodiments, a single port cover portion may be provided that is removably located within the ejection port 36. It will be appreciated that in such embodiments the sliding cover portion must be configured so as not to be dislodged by air pressure that builds up within the filter housing during operation of the air filter assembly.

As such, in the open configuration debris-laden air is ejected from the ejection port 36 as it is stratified by the centrifugal force. This may be by the debris-laden air passing through apertures in the first portion 40 of the interlocking port cover arrangement 38. In the closed configuration, whereby the ejection portion 36 is sealed, the air is filtered solely through the air filter 20.

In the open configuration, it is envisioned that the air filter assembly 1 may be used to filter air from external environments that may be particularly debris-laden or dirty. In such a configuration, the air filter assembly 1 may be open ended at the end having the inlet or include a cover attachment arrangement 44.

The cover attachment arrangement 44 includes an adaptor 46 and a cover 48. The adaptor 46 provides a mechanical interface between the cover 48 and the inlet housing 4. As such, the adaptor 46 is configured to removably connect to the inlet housing 4 adjacent the inlet. The adaptor 46 may be useful for controlling the proximity of the cover 48 to the fan 10 whilst presenting minimal restriction to airflow into the housing assembly 2. That is, the adaptor 46 spaces the cover 48 from the fan 10 to minimise the impact of the cover 48 on the ability of the fan 10 to draw in air. In this regard, the adaptor 46 is substantially cylindrical being open at one end adjacent the inlet housing 4 and with multiple apertures formed in a face adjacent the cover 48 and/or distal from the inlet housing 4.

The cover attachment arrangement 44 acts as a raincap to allow the air filter assembly 1 to be oriented either horizontally or vertically while preventing or at least limiting ingress of water into the housing assembly. The cover attachment arrangement 44 also prevents debris from blocking the fan and guards against direct blasts of water that may occur during washing.

As can be seen in the cross-section, the adaptor 46 mates with the inlet housing 4 and constrains the fan by retaining mount lugs on the fan shroud into corresponding recesses in the inlet housing. The intake leg mount sandwiches the three components, locating them axially and radially.

In the closed configuration, it is envisioned that the air filter assembly 1 may be used for air recirculation such that air from a cabin or enclosed environment is communicated from the cabin or similar to the air filter assembly 1 to filter particulate matter that may have entered the cabin and may pose a health risk to anyone present in the space. In such embodiments, the air filter assembly 1 may further include a spigot 50 connected to the inlet housing 16 such that the inlet is between a body of the inlet housing 4 and the spigot 50. The spigot 50 (in some embodiments, a duct spigot or air inlet spigot) is substantially conical and configured to connect to a source of air, i.e., a hose or pipe communicating air from a cabin to the air filter assembly. In the illustrated embodiment, the spigot 50 is conical with an open ended base and an open ended cylindrical portion opposite the base (at the apex of the cone). The air is then filtered through the air filter assembly 1 and returned to the space through the clean air outlet 28.

In use, the method of operating the air filter assembly 1 is as follows. First, an air filter 20 having a sensor or magnet located thereon is provided. Next, the air filter 20 is operably located within a housing assembly 2 of the air filter assembly 1, whereby the operable location of the air filter 20 within the housing assembly 2 positions the magnet or sensor in operable communication with a corresponding control switch or control sensor located within the housing assembly 2 to control a fan 10 of the air filter assembly 1 that draws air into an inlet of an inlet housing 4 of the housing assembly 2 for filtering.

In another example of use, the method of configuring the air filter assembly 1 is as follows. First, a filter housing 8 having an open ejection port 36 formed therein is provided. Next, the ejection port 36 is configured in a closed configuration by closing the open ejection port 36 to provide for recirculation within a housing assembly 2 of the air filter assembly 1.

In some embodiments, the ejection port 36 may then be reconfigured from the closed configuration to an open configuration by opening the ejection port 36.

In the illustrated embodiment, the housing assembly is made up of two discrete housing portions that are connected together but in some embodiments the housing assembly may include a single housing portion including both the inlet housing portion and the filter housing portion being integrally formed.

In compliance with the statute, the invention has been described in language more or less specific to structural or methodical features. The term “comprises” and its variations, such as “comprising” and “comprised of” is used throughout in an inclusive sense and not to the exclusion of any additional features.

It is to be understood that the invention is not limited to specific features shown or described since the means herein described comprises preferred forms of putting the invention into effect.

The invention is, therefore, claimed in any of its forms or modifications within the proper scope of the appended claims appropriately interpreted by those skilled in the art.

1. An air filter assembly comprising:
a housing assembly comprising:
an inlet housing having an inlet for receiving air, and
a filter housing configured to receive and house an air filter, the filter housing being connected to the inlet housing to receive air therefrom and having a port cover arrangement and an ejection port formed therein,
wherein the ejection port is configurable between an open configuration and a closed configuration;
wherein the port cover arrangement is located within a wall of the filter housing,
wherein the open configuration is selected by opening the port cover arrangement to uncover the ejection port and the closed configuration is selected by closing the port cover arrangement to cover the ejection port;
wherein, in the open configuration, debris is ejected from the ejection port and, in the closed configuration, debris-laden air is filtered through the air filter;
a fan with one or more blades configured to draw air into the inlet housing;
an airflow control system positioned relative to the fan to cause air drawn into the inlet to rotate within the inlet housing toward the filter housing and cause particles within the air to be forced toward a wall of the filter housing;
a removable air filter located within the filter housing and configured to filter the rotating air flow received from the inlet housing, the air filter having an internal passage to receive air from the filter housing through walls of the air filter; and
a clean air outlet connected to the internal passage of the air filter for ejecting air received into the internal passage of the air filter.

2. The air filter assembly according to claim 1, wherein the air filter assembly further comprises a spigot connected to the inlet housing, such that the inlet is between a body of the inlet housing and the spigot.

3. The air filter assembly according to claim 2, wherein the spigot is configured to connect to a source of air.

4. The air filter assembly according to claim 3, wherein the spigot is substantially conical.

5. The air filter assembly according claim 1, wherein the air filter assembly further comprises an interlock arrangement to operate and control at least one of the fan and a motor of the fan when the air filter is located within the air filter housing.

6. The air filter assembly according to claim 5, wherein the interlock arrangement includes one or more sensors or magnets connected to the air filter.

7. The air filter assembly according to claim 5, wherein the air filter includes one or more sensors or magnets.

8. The air filter assembly according to claim 7, wherein the one or more sensors or magnets are located at an end of the air filter.

9. The air filter assembly according to claim 8, wherein two sensors or magnets, of the one or more sensor or magnets, are located at the end of the air filter and spaced apart about the end of the air filter.

10. The air filter assembly according to claim 8, wherein the interlock arrangement includes a control sensor or control switch located in the housing assembly and configured to detect a presence of the one or more sensors or magnets of the air filter.

11. The air filter assembly according to claim 10, wherein the control sensor or control switch is positioned within the housing assembly to be adjacent to or directly adjacent to the one or more sensors or magnets of the air filter when the air filter is operably located within the housing assembly.

12. The air filter assembly according to claim 10, wherein the control sensor or control switch is connected to and configured to control the fan in response to detection of the one or more sensors or magnets of the air filter.

13. The air filter assembly according to claim 10, wherein the control sensor or control switch is configured to detect the one or more sensors or magnets of the air filter that is adjacent or directly adjacent the control sensor or control switch.

14. The air filter assembly according to claim 10, wherein in use, without detection of the one or more sensors or magnets of the air filter, the fan is configured to at least one of not operate and only operate in response to detection of the one or more sensors or magnets of the air filter.

15. The air filter assembly according to claim 1, wherein the filter housing is releasably connected to the inlet housing.

16. The air filter assembly according to claim wherein at least one of the removable air filter and the housing assembly comprises one or more sensors within the housing assembly configured to detect operating conditions and for data communication with a remote system.

17.-21. (canceled)

22. The air filter assembly according to claim 1, wherein the port cover arrangement comprises a sliding port cover arrangement, the sliding port cover arrangement including a first portion having an opening and a sliding cover portion adapted to slide over and seal the opening.

23. The air filter assembly according to claim 1, wherein the port cover arrangement comprises a rotating collar located within a wall of the filter housing.

24. The air filter assembly of claim 1, wherein the airflow control system includes a complementary recess formed therein, and wherein the removable air filter includes a portion shaped to be received by the complementary recess such that when the portion is received by the complementary recess and rotated about a longitudinal axis, the removable air filter is securely located within the filter housing to prevent withdrawal of the removable air filter by pulling.

25. A method of configuring an air filter assembly, the method including:
providing a filter housing having a port cover arrangement and an open ejection port formed therein,
wherein the port cover arrangement is located within a wall of the filter housing, and
wherein an open configuration is selected by opening the port cover arrangement to uncover the ejection port and a closed configuration is selected by closing the port cover arrangement to cover the ejection port;
configuring the ejection port in a closed configuration by closing the open port cover arrangement and ejection port to provide for recirculation within a housing assembly of the air filter assembly; and
configuring the ejection port in the open configuration by opening a port cover arrangement and the ejection port.
